(19) United States
(12) Patent Application Publication
(10) Pub. No.: US 2026/0246388 A1
(43) Pub. Date: Aug. 20, 2026

(54) Input Overvoltage Protection in a Power Converter

(71) Applicant: TEXAS INSTRUMENTS INCORPORATED, Dallas, TX (US)

(72) Inventors: Prathamesh Pilankar, Mumbai (IN); Michael Lueders, Freising (DE); Suvadip Banerjee, Bangalore (IN); Bharat Agrawal, Bangalore (IN); Akhila Gundavarapu, Bangalore (IN)

(21) Appl. No.: 19/313,957

(22) Filed: Aug. 29, 2025

(30) Foreign Application Priority Data
Feb. 19, 2025 (IN) 202541014435

(51) Int. Cl. H02M 3/335

(52) U.S. Cl. CPC H02M 3/335

(57) ABSTRACT

An apparatus includes a transistor having a first terminal and a control terminal and a controller having a first output coupled to the control terminal. A discharge circuit has a first discharge circuit terminal and is coupled to a ground terminal. The first discharge circuit terminal is coupled to the first terminal. The discharge circuit is configurable to determine a value proportional to an average of a signal at the first terminal, compare the value to a reference signal, and, responsive to the value exceeding the reference signal, enable a discharge current path from the first terminal to the ground terminal.

### CROSS-REFERENCE TO RELATED APPLICATIONS

This application claims priority to India Provisional Application No. 202541014435, filed Feb. 19, 2025, which is hereby incorporated by reference.

### BACKGROUND

A power converter converts an input voltage into an output voltage to power a load. One type of power converter is a flyback converter. Power converters may include one or more transistors which turn on and off to provide current to the load. The main power transistor in a power converter, such as a flyback converter, can be damaged in the event of a power surge (or other cause for an increase in the input voltage) at the input of converter.

### SUMMARY

In an example, an apparatus includes a transistor having a first terminal and a control terminal and a controller having a first output coupled to the control terminal. A discharge circuit has a first discharge circuit terminal and a ground terminal. The first discharge circuit terminal IS coupled to the first terminal. The discharge circuit is configurable to determine a value proportional to an average of a signal at the first terminal, compare the value to a reference signal, and, responsive to the value exceeding the reference signal, enable a discharge current path from the first terminal to the ground terminal.

In another example, an apparatus includes a first transistor having a first terminal and a first control terminal. A controller has a first output coupled to the first control terminal. A filter has an input coupled to the first terminal and has an output. A comparator has a first comparator input coupled to the output of the filter. The comparator also has a second comparator input and a comparator output. A reference signal circuit is coupled to the second comparator input. A second transistor has a second terminal and a second control terminal. The second terminal is coupled to the first terminal, and the second control terminal is coupled to the comparator output.

In yet another example, a method includes determining a value indicative of an average of a signal at a terminal of an inductor of a power converter. The method also includes determining that the value exceeds a reference signal. Responsive to the value exceeding the reference signal, the method includes discharging a capacitor coupled to the inductor.

### BRIEF DESCRIPTION OF THE DRAWINGS

FIG. 1 is a schematic diagram of a power converter which includes a discharge circuit, in accordance with an example.

FIG. 2 is a schematic diagram of the discharge circuit of FIG. 1, in an example.

FIG. 3 is a schematic diagram of the discharge circuit including an implementation of a filter within the discharge circuit, in an example.

FIG. 4 is a flowchart of a method illustrating the operation of the discharge circuit, in an example.

### DETAILED DESCRIPTION

The same reference numbers or other reference designators are used in the drawings to designate the same or similar (either by function and/or structure) features.

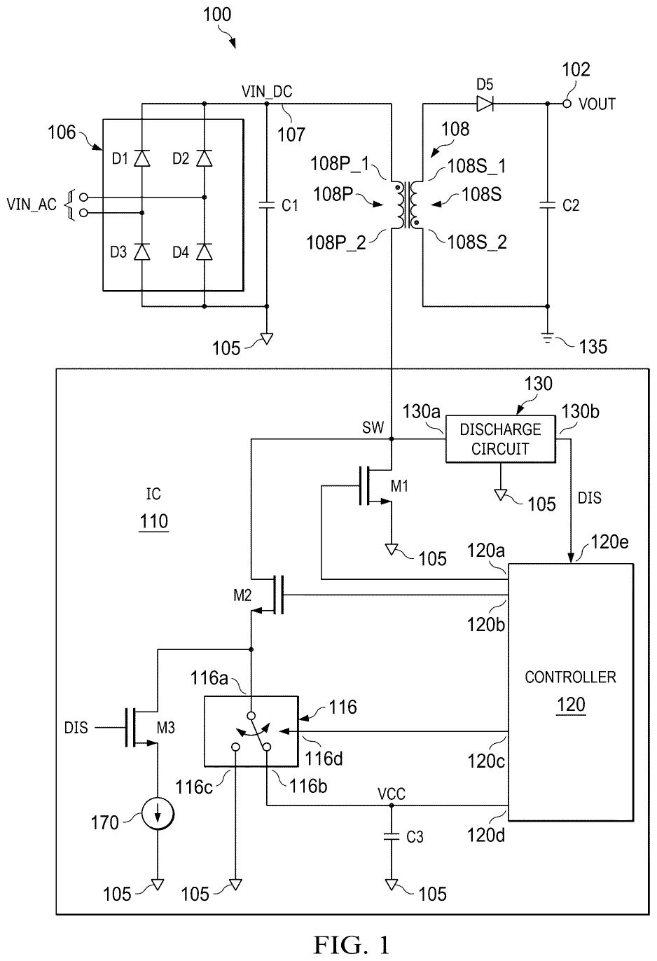

FIG. 1 is a schematic diagram of a power converter 100, in an example. In this example, power converter 100 is a flyback converter. However, the principles described herein may be applicable to other types of power converters. Power converter 100 includes a full-wave rectifier 106, capacitors C1, C2, and C3, transistors M1, M2, and M3, a current source circuit 170, a transformer 108, diode D5 (or other type of rectifying device), a switch circuit 116, a controller 120, and a discharge circuit 130. Full-wave rectifier 106 includes diodes D1, D2, D3, and D4. Diodes D1 and D3 are coupled in series between a reference terminal (e.g., ground) 105 and a direct current (DC) voltage terminal 107. The voltage at the DC voltage terminal 107 is a DC input voltage VIN_DC. Similarly, diodes D2 and D4 are coupled between the reference terminal 105 and the DC voltage terminal 107. An alternating current input voltage, VIN_AC, is provided to the full-wave rectifier 106. Full wave rectifier 106 rectifies VIN_AC into VIN_DC at DC voltage terminal 107. VIN_DC represents the DC input voltage to power converter 100. Capacitor C1 is coupled between the DC voltage terminal 107 and the reference terminal 105. Capacitor C1 is charged to the voltage VIN_DC. Capacitor C1 may also be referred to as a bulk capacitor.

Transformer 108 includes a primary coil 108P and a secondary coil 108S. Primary coil 108P has terminals 108P-1 and 108P-2. Secondary coil 108S has terminals 108S-1 and 108S-2. Terminal 108P-1 is coupled to the DC voltage terminal 107. Terminal 108S-1 is coupled to the anode of diode D5. Capacitor C2 is coupled between the cathode of diode D5 and terminal 108S-2, which is coupled to a reference terminal 135. The cathode of diode D5 is coupled to the output terminal 102 of power converter 100 and provides the output voltage VOUT.

In the example of FIG. 1, transistors M1 and M2 are n-channel field effect transistors (NFETs) such as gallium nitride (GaN) transistors. Transistor M3 may also be an NFET (e.g., a silicon FET or a GaN FET). The drains of transistors M1 and M2 are coupled together and to terminal 108P-2 of primary coil 108P at a switching terminal SW. The source of transistor M1 is coupled to the reference terminal 105. The drain of transistor M3 is coupled to the source of transistor M2. Current source circuit 170 is coupled between the source of transistor M3 and the reference terminal 105. Controller 120 has outputs 120a, 120b, and 120c, a supply voltage terminal 120d, and an input 120e. Output 120a is coupled to the gate of transistor M1. Output 120b is coupled to the gate of transistor M2. Switch circuit 116 has switch terminals 116a, 116b, and 116c, and a control input 116d. Output 120c of controller 120 is coupled to the control input 116d of switch circuit 116. Switch terminal 116a is coupled to the source of transistor M2. Switch terminal 116b is coupled to the supply voltage terminal 120d. Capacitor C3 is coupled between switch terminal 116b and the reference terminal 105. Capacitor C3 is charged to a voltage labeled VCC. VCC provides the operating voltage for controller 120.

Based on the logic state of a control signal at output 120c of controller 120, switch terminal 116a is either electrically coupled to switch terminal 116b or to switch terminal 116c. If VCC falls below a threshold, controller 120 asserts a control signal at its output 120c to cause switch circuit 116 to electrically couple the source of transistor M2 to capacitor C3 to provide a path for current to charge capacitor C3 to thereby cause VCC to increase. Otherwise, controller 120 causes switch circuit 116 to electrically couple transistor M2 to the reference terminal 105. In one example, power converter 100 does not include an auxiliary winding of transformer 108 to supply bias current for generating VCC for the controller. Such a flyback converter may be referred to as an “auxless” flyback converter.

When controller 120 enables (e.g., turns on) transistor M1, current flows from the DC voltage terminal 107 through the primary coil 108P of transformer 108 and transistor M1. The magnetic flux in transformer 108 increases thereby storing energy in the transformer. The voltage induced in the secondary coil 108S is negative which causes diode D5 to be reverse-biased. While transistor M1 is on, capacitor C2 supplies current to a load which may be coupled to the output terminal 102 of power converter 100. When controller 120 disables (e.g., turns off) transistor M1, the primary current through the primary coil 108P decreases as does the transformer's magnetic flux. The voltage across the secondary coil 108S is positive, thereby forward-biasing diode D5 and allowing current to flow from the transformer to the load and to recharge capacitor C2.

When transistor M1 is off, the voltage at the drain of transistor M1 is VIN_DC+N*VOUT, where N is turns ratio of transformer 108. Accordingly, the drain-to-source voltage, Vds, of transistor M1 is VIN_DC+N*VOUT when transistor M1 is off. During an input power surge or other anomalous event, VIN_AC, and thus VIN_DC, may increase from its nominal value thereby causing an increase in the Vds of transistor M1. The Vds of transistor M1 may become large enough so as to damage transistor M1. Further, as VIN_DC increases, the charge on capacitor C1 further increases. Even after the power surge ends, capacitor C1 may remain charged to a voltage in excess of the nominal value of VIN_DC.

Discharge circuit 130 has an input 103a and an output 130b. Input 130a is coupled to SW, and output 130b is coupled to input 120e of controller 120 and to the gate of transistor M3. Discharge circuit 130 generates a disable (DIS) signal at its output 130b which is provided to controller 120 and to the gate of transistor M3. As described below, discharge circuit 130 determines the magnitude of VIN_DC by determining the average of V_SW—the voltage at SW. When transistor M1 is on, SW is at 0V. When transistor M1 is off, SW is at VIN_DC+N*VOUT. The average voltage of SW is VIN_DC. Discharge circuit 130 monitors SW to determine VIN_DC. In response to VIN_DC exceeding a threshold, discharge circuit 130 asserts DIS to a logic state (e.g., logic high) to cause controller 120 to discontinue switching transistor M1, e.g., turn transistor M1 off until DIS changes logic state. Controller also turns on transistor M2 in response to an assertion of DIS. DIS also causes transistor M3 to turn on to enable a discharge current path from the SW to the reference terminal 105 to thereby discharge capacitor C1. The current through the discharge current path through transistor M3 is controlled by the current source circuit 170.

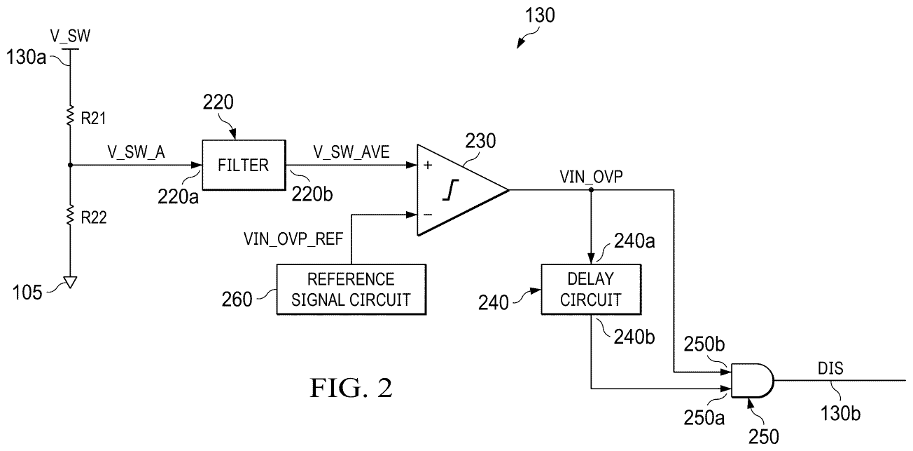

FIG. 2 is a schematic diagram of a discharge circuit 130, in an example. In this example, discharge circuit 130 includes resistors R21, R22, a filter 220, a comparator 230, a delay circuit 240, an AND gate 250 (or other type of logic gate), and a reference signal circuit 260. Resistors R21 and R22 are coupled in series between input 130a and the reference terminal 105. Resistors R21 and R22 represent a voltage divider to divide down V_SW to V_SW_A. Voltage V_SW_A is provided to an input 220a of filter 220. Filter 220 may be an averaging filter, e.g., a low-pass filter. The output 220b of filter 220 is provided to the positive (+) input of comparator 230. The output of reference signal circuit 260, which provides a reference signal VIN_OVP_REF, is coupled to the negative (−) input of comparator 230.

Comparator 230 produces an output signal VIN_OVP. The output of comparator 230 is coupled to an input 240a of delay circuit 240. AND gate 250 has inputs 250a and 250b. The output 240b of delay circuit 240 is coupled to input 250a of AND gate 250. The output of comparator 230 also is coupled to the input 250b of AND gate 250. The output of AND gate 250 is coupled to the output 130b of discharge circuit 130. The output signal from AND gate 250 is DIS.

As described above, filter 220 is an averaging filter which produces an output signal V_SW_AVE that is an average of V_SW_A. Because V_SW_A is a scaled version of V_SW, V_SW_AVE produced by filter 220 is proportional to the average of V_SW. The average of V_SW is VIN_DC Accordingly, V_SW_AVE is proportional to VIN_DC. Comparator 230 compares V_SW_AVE to VIN_OVP_REF produced by reference signal circuit 260. In one example, comparator 230 produces VIN_OVP as a logic high signal when V_SW_AVE is greater than VIN_OVP_VREF and as a logic low signal when V_SW_AVE is smaller than VIN_OVP_VREF. VIN_OVP_REF is set at a magnitude such that comparator 230 forces VIN_OVP to a logic high level to protect transistor M1 from an excessively high VIN_DC.

AND gate 250 receives VIN_OVP as well as a delayed version of VIN_OVP. The time delay implemented by delay circuit 240 may be, for example, 1 millisecond (ms). AND gate 250 forces DIS logic high when VIN_OVP is logic high and the delayed version of VIN_OVP also is logic high. In other words, delay circuit 240 implements a deglitch function to cause AND gate 250 to force DIS logic high when VIN_OVP persists at a logic high level for at least the time delay of delay circuit 240 (e.g., 1 ms). In other examples, other logic gate can be used in place of AND gate 250 to set the desired state of the DIS to provide the deglitch function.

DIS being logic high (or in other target logic state) can cause controller 120 to turn on transistor M2 and cause transistor M3 (FIG. 1) to turn on thereby enabling a discharge current path for capacitor C1. With transistor M3 on, capacitor C1 discharges through primary coil 108P and transistors M2 and M3 to the reference terminal 105. Current source 170 controls the magnitude of the discharge current from capacitor C1. In response to a logic high assertion of DIS, controller 120 also discontinues switching transistor M1, as noted above.

When the input voltage VIN_DC decreases to a level at which comparator 230 forces VIN_OVP to change logic state (e.g., from high to low logic state), AND gate 250 forces DIS logic low. As a result of DIS being logic low, transistor M3 turns off thereby discontinuing the discharging of capacitor C1. The change in logic state of DIS also causes controller 120 to begin switching cycles of transistor M1.

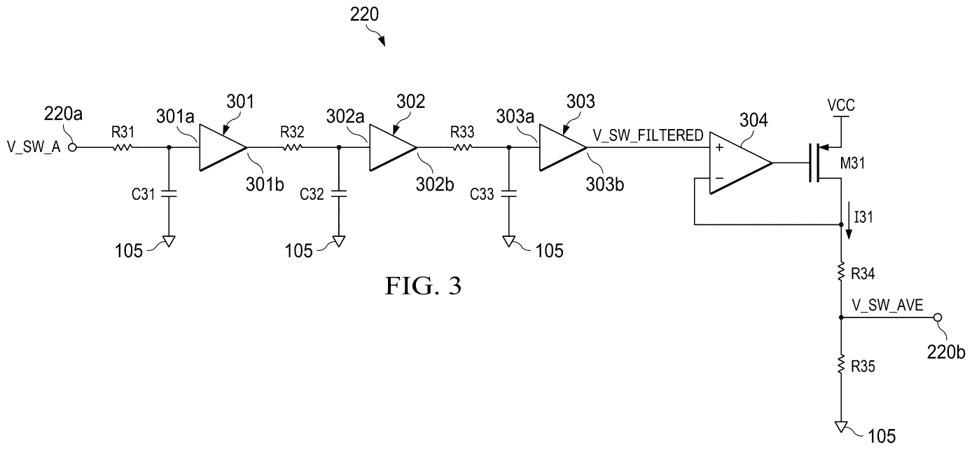

FIG. 3 is a schematic diagram of filter 220, in an example. In the example of FIG. 3, filter 220 is a third-order, low-pass filter. In other examples, filter 220 is an n-order low-pass filter in which n is at least one. Filter 220 may include resistors R31, R32, R33, R34, and R35, capacitors C31, C32, and C33, buffers 301, 302, and 303, amplifier (e.g., an operational amplifier) 304, and transistor M31. Resistor R31 is coupled between input 220a and an input 301a of buffer 301. One terminal of capacitor C31 is coupled to the input 301a and the other terminal of capacitor C31 is coupled to the reference terminal 105. Resistor R32 is coupled between the output 301b of buffer 301 and an input 302a of buffer 302. One terminal of capacitor C32 is coupled to the input 302a and the other terminal of capacitor C32 is coupled to the reference terminal 105. Resistor R33 is coupled between the output 302b of buffer 302 and an input 303a of buffer 303. One terminal of capacitor C33 is coupled to the input 303a and the other terminal of capacitor C33 is coupled to the reference terminal 105. The combination of resistor R31/capacitor C31, resistor R32/capacitor C32, and resistor R33/capacitor C33 represents a third-order, low-pass filter. The output voltage from buffer 303 is a voltage V_SW_FILTERED.

The output 303b of buffer 303 is coupled to a positive input of operational amplifier 304. Transistor M31 is a p-channel field effect transistor (PFET) in this example. The output of operational amplifier 304 is coupled to the gate of transistor M31. The source of transistor M31 receives the operating voltage VCC. Transistors R34 and R35 are coupled in series, forming a voltage divider, between the drain of transistor M31 and the reference terminal 105. The drain of transistor M31 is also coupled to the negative input of operational amplifier 304. The combination of operational amplifier 304, transistor M31, and resistors R34 and R35 form a voltage-to-current converter which converts voltage V_SW_FILTERED to a current I31. Current I31 is based on, e.g., proportional to, voltage V_SW_FILTERED. Current I31 flows through resistors R34 and R35 and generates the signal (e.g., voltage) V_SW_AVE across resistor R35 at output 220b.

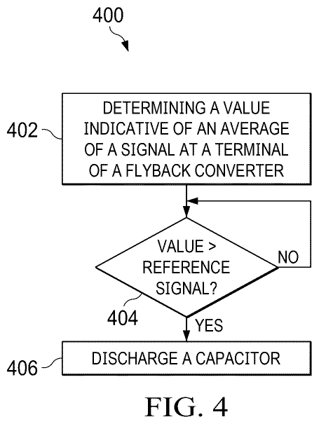

FIG. 4 is a flowchart illustrating a method 400, in an example. At operation 402, method 400 includes determining a value indicative of an average of a signal at a terminal of a flyback converter. In one example, an averaging filter (e.g., filter 220) determines the value by low-pass filtering V_SW to produce signal V_SW_AVE, as described above. At decision 404, the method includes determining whether the value determined at operation 402 is greater than a reference signal. In one example, the reference signal is VIN_OVP_REF, described above. If the value is less than the reference signal, then control loops back on decision 404. If and when the value is greater than the reference signal, then the method performs operation 406 by which a capacitor is discharged. In an example, the capacitor being discharged is capacitor C1. Capacitor C1 may be discharged by turning on a transistor (e.g., transistor M3) and controlling the discharge current from capacitor C1 by a current source circuit (e.g., current source circuit 170).

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” or “configurable to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) or a p-channel FET (PFET)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input is the gate, and the current terminals are the drain and source. In the context of a BJT, the control input is the base, and the current terminals are the collector and emitter. The gate, source, and drain of a FET and base, collector, and emitter of a BJT are terminals of the transistor.

References herein to a FET being “ON” or “enabled” means that the conduction channel of the FET is present and drain current may flow through the FET. References herein to a FET being “OFF” or “disabled” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

What is claimed is:

1. An apparatus, comprising:
a transistor having a first terminal and a control terminal;
a controller having a first output coupled to the control terminal; and
a discharge circuit having a first discharge circuit terminal and coupled to a ground terminal, the first discharge circuit terminal coupled to the first terminal, the discharge circuit configurable to determine a value proportional to an average of a signal at the first terminal, compare the value to a reference signal, and, responsive to the value exceeding the reference signal, enable a discharge path from the first terminal to the ground terminal.

2. The apparatus of claim 1, wherein the discharge circuit includes a filter having an input coupled to the first terminal and having an output.

3. The apparatus of claim 2, wherein the filter is an averaging filter.

4. The apparatus of claim 2, wherein the filter is an n-order low-pass filter, wherein n is at least one.

5. The apparatus of claim 2, wherein the transistor is a first transistor, the apparatus further includes a second transistor having a second terminal coupled to the first terminal and having a control terminal, and wherein the discharge circuit includes:
a comparator having first and second comparator inputs and a comparator output, the first comparator input coupled to the output of the filter, the comparator output coupled to the control terminal of the second transistor; and
a reference signal circuit coupled to the second comparator input.

6. The apparatus of claim 5, wherein the second transistor has a third terminal, and wherein the apparatus includes a current source circuit coupled between the third terminal and the ground terminal.

7. The apparatus of claim 5, wherein the discharge circuit includes:
a delay circuit having an input coupled to the comparator output and having an output; and
a logic gate having first and second logic gate inputs and a logic gate output, the first logic gate input coupled to the output of the delay circuit, the second logic gate input coupled to the output of the comparator, and the logic gate output coupled to the control terminal of the second transistor.

8. The apparatus of claim 7, wherein the logic gate includes an AND gate.

9. The apparatus of claim 1, further comprising:
a transformer having first, second, third, and fourth terminals, the second terminal of the transformer coupled to the first terminal of the transistor;
a capacitor coupled between the first terminal of the transformer and the ground terminal; and
a rectifying device coupled to at least one of the third or fourth terminals of the transformer.

10. The apparatus of claim 9, further comprising a full-wave rectifier coupled across the capacitor.

11. An apparatus, comprising:
a first transistor having a first terminal and a first control terminal;
a controller having a first output coupled to the first control terminal; and
a filter having an input coupled to the first terminal and having an output;
a comparator having a first comparator input coupled to the output of the filter, a second comparator input, and a comparator output;
a reference signal circuit coupled to the second comparator input; and
a second transistor having a second terminal and a second control terminal, the second terminal coupled to the first terminal, and the second control terminal coupled to the comparator output.

12. The apparatus of claim 11, further comprising:
a delay circuit coupled between the output of the comparator and the second control terminal of the second transistor.

13. The apparatus of claim 11, further comprising:
a delay circuit having an input coupled to the comparator output and having an output; and
a logic gate having first and second inputs and an output, the first input of the logic gate coupled to the output of the delay circuit, the second input of the logic gate coupled to the comparator output, and the output of the logic gate coupled to the second control terminal of the second transistor.

14. The apparatus of claim 13, wherein the logic gate is an AND gate.

15. The apparatus of claim 11, wherein the filter is an averaging filter.

16. The apparatus of claim 11, wherein the filter is an n-order low-pass filter, wherein n is at least two.

17. The apparatus of claim 11, wherein at least the first transistor is part of a flyback converter.

18. The apparatus of claim 11, wherein the first transistor has a second terminal, and the apparatus further comprises a third transistor coupled between the second terminal of the first transistor and the second terminal of the second transistor.

19. A method, comprising:
determining a value indicative of an average of a signal at a terminal of an inductor of a power converter;
determining that the value exceeds a reference signal; and
responsive to the value exceeding the reference signal, discharging a capacitor coupled to the inductor.

20. The method of claim 19, wherein discharging the capacitor includes enabling a transistor coupled to the terminal and controlling a discharge current from the capacitor using a current source circuit.

21. The method of claim 19, wherein determining that the value exceeds the reference signal includes determining that the value exceeds the reference signal for at least 1 ms.
